(19) United States
(12) Patent Application Publication
(10) Pub. No.: US 2026/0050853 A1
(43) Pub. Date: Feb. 19, 2026

(54) INTELLIGENT WORKFLOW DESIGN BASED ON INTELLIGENCES AND STRENGTHS FOR WORKFLOW STEPS

(71) Applicant: International Business Machines Corporation, Armonk, NY (US)

(72) Inventors: Michael Boone, Lutz, FL (US); Sarbajit Kumar Rakshit, KOLKATA (IN); Carolina Garcia Delgado, Zapopan (MX); Jennifer M. Hatfield, Portland, OR (US)

(73) Assignee: International Business Machines Corporation, Armonk, NY (US)

(21) Appl. No.: 18/804,280

(22) Filed: Aug. 14, 2024

(51) Int. Cl. G06Q 10/0633

(52) U.S. Cl. CPC G06Q 10/0633

(57) ABSTRACT

According to a technique of designing an intelligent workflow, a processor determines an intelligent workflow including a plurality of workflow steps to be performed. The processor performs digital twin simulation of performance of the intelligent workflow in a physical production environment. The processor determines, based on the digital twin simulation, at least one type of intelligence among a plurality of types of intelligences to be allocated to each of multiple of the plurality of workflow steps. The processor determines multiple types of intelligences for the plurality of workflow steps. The processor allocates and deploys, in the physical production environment, production resources possessing the determined types of intelligences. The processor thereafter iteratively optimizes the intelligent workflow based on observation of execution of the intelligent workflow by the deployed performance resources in the physical production environment.

### BACKGROUND OF THE INVENTION

The present invention relates in general to data processing, and more specifically, to intelligent workflow design. Still more particularly, the present invention relates to intelligent workflow design based on intelligences and strengths for workflow steps.

In today's rapidly evolving business landscape, organizations face unprecedented challenges in maintaining a competitive edge. Recent market changes and disruptions have highlighted the critical need for a workforce equipped with digital skills and innovative processes to respond effectively to both customers'and employees'evolving needs. Organizations that can maintain a flexible workforce, both in terms of strategies and skills, are better positioned to adapt to market trends and meet customer expectations.

Traditional business management approaches often struggle to keep pace with these rapid changes. Many organizations face difficulties in aligning their workforce strategy with business priorities, improving productivity and process optimization, retaining valuable employees, empowering a changing workforce, identifying and reducing skills gaps, and enhancing overall employee experiences. These challenges are further exacerbated by the increasing prevalence of remote and hybrid work models.

Existing solutions have attempted to address these issues through various means, such as implementing standalone HR software, conducting periodic skills assessments, or introducing employee engagement initiatives. However, these approaches often lack the integration and real-time responsiveness required to effectively manage talent and business processes in today's dynamic business environment.

Furthermore, while many organizations recognize the importance of digital transformation, they often struggle to implement comprehensive solutions that leverage the full potential of data and technology in the management of talent and business processes. This has resulted in a significant gap between the need for agile, data-driven management of talent and business processes and the capabilities of current systems.

There is a growing recognition of the potential for intelligent workflows to transform management processes. Intelligent workflows, which enable employees and business processes to thrive at the intersection of skills, data, and technology, offer a promising solution to many of the challenges faced by modern organizations in managing their workforce and business processes. However, the development and implementation of effective intelligent workflows for business processes present several technical challenges, including the alignment of intelligences and strengths of digital, machine, and human agents with the requirements of workflows.

The present application recognizes the need for innovative solutions that can effectively leverage intelligent workflows to address the complex challenges of modern workflow management.

### SUMMARY OF THE INVENTION

According to at least one embodiment of a technique of designing an intelligent workflow, a processor determines an intelligent workflow including a plurality of workflow steps to be performed. The processor performs digital twin simulation of performance of the intelligent workflow in a physical production environment. The processor determines, based on the digital twin simulation, at least one type of intelligence among a plurality of types of intelligences to be allocated to each of multiple of the plurality of workflow steps. The processor determines multiple types of intelligences for the plurality of workflow steps. The processor allocates and deploys, in the physical production environment, production resources possessing the determined types of intelligences. The processor thereafter iteratively optimizes the intelligent workflow based on observation of execution of the intelligent workflow by the deployed performance resources in the physical production environment.

### BRIEF DESCRIPTION OF THE DRAWINGS

FIG. 1 is a high-level block diagram of an exemplary data processing environment in accordance with one or more embodiments; and

FIG. 2 is a high-level block diagram of an exemplary process of intelligent workflow design in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code, such as intelligent workflow manager 150, involved in performing the inventive methods. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and other code and data), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

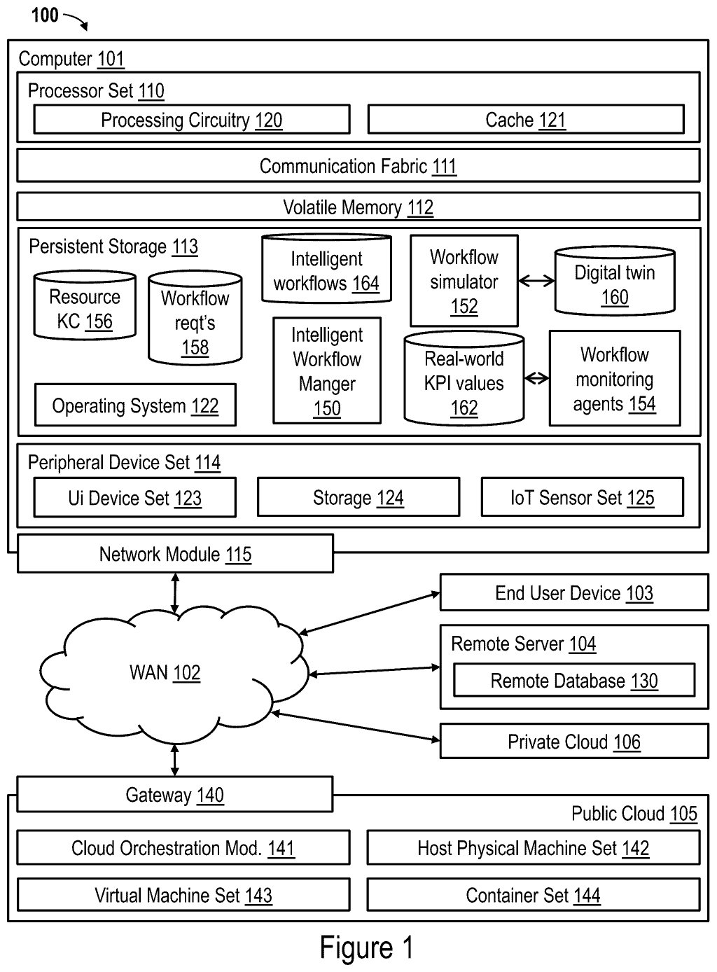

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be implemented in intelligent workflow manager 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

In one or more embodiments, intelligent workflow manager 150 or components thereof can be executed, for example, by processing circuitry 120, remote server 104, private cloud 106, and/or on public cloud 105 in order to design and optimize an intelligent workflow. In at least some embodiments, intelligent workflow manager 150 may collaborate with (or in some embodiments, include) additional software components, such as a workflow simulator 152 and workflow monitoring agent(s) 154. Intelligent workflow manager 150, workflow simulator 152, and/or workflow monitoring agent(s) 154 may also access datasets, including resource knowledge corpus 156, workflow requirements 158, digital twin 160, real-world key performance indicator (KPI) values 162, and existing (historical) intelligent workflows 164. In one or more embodiments, intelligent workflow manager 150 employs these code components and datasets to design and optimize intelligent workflows. Intelligent workflow manager 150 preferably designs and optimizes an intelligent workflow based on the intelligences and strengths of various performance resources allocated to perform the workflow steps of the intelligent workflow.

As utilized herein, an “intelligent workflow” refers to an automated process that incorporates one or more advanced technologies, such as artificial intelligence (AI), machine learning (ML), natural language processing (NPL), data analytics, and/or robotic process automation (RPA), to optimize and enhance a business process. An intelligent workflow can be implemented, for example, to make the business process more efficient, reduce manual intervention, minimize errors, and/or improve decision-making. An intelligent workflow can be applied to a wide variety of industries and problem domains, including healthcare, finance, manufacturing, physical distribution, education, and customer service, among others. In at least some embodiments, intelligent workflow design and optimization may involve the following additional concepts:
“workflow monitoring”: gathering data regarding the performance of the intelligent workflow in the real world through tracking each step in a process, including workflow step initiation and completion.
“key performance indicator (KPI)”: a variable aspect of the intelligent workflow for which a quantifiable measure can be obtained by workflow monitoring.
“performance analysis”: comparison of data gathered through workflow monitoring to performance targets, for example, to enable identification of process bottlenecks, delays, and/or inefficiencies and corrective actions and/or workflow modifications that can be taken to improve process efficiency.
“performance resource”: an executable code component, machine, or human worker (“talent”) capable of assignment to perform a step of the intelligent workflow.
“performance resource allocation”: an assignment of performance resources to steps of an intelligent workflow.
“quality control”: monitoring one or more outputs of one or more workflow steps to qualify the output(s) as meeting a quality standard.
“compliance monitoring”: monitoring one or more steps of the intelligent workflow with regard to whether the step(s) satisfy an internal (e.g., company) or external (e.g., industry or governmental) regulation or policy, which in some cases can require an audit trail.
“adaptability”: the capability of the intelligent workflow to be modified based on changing real-world conditions and/or events.

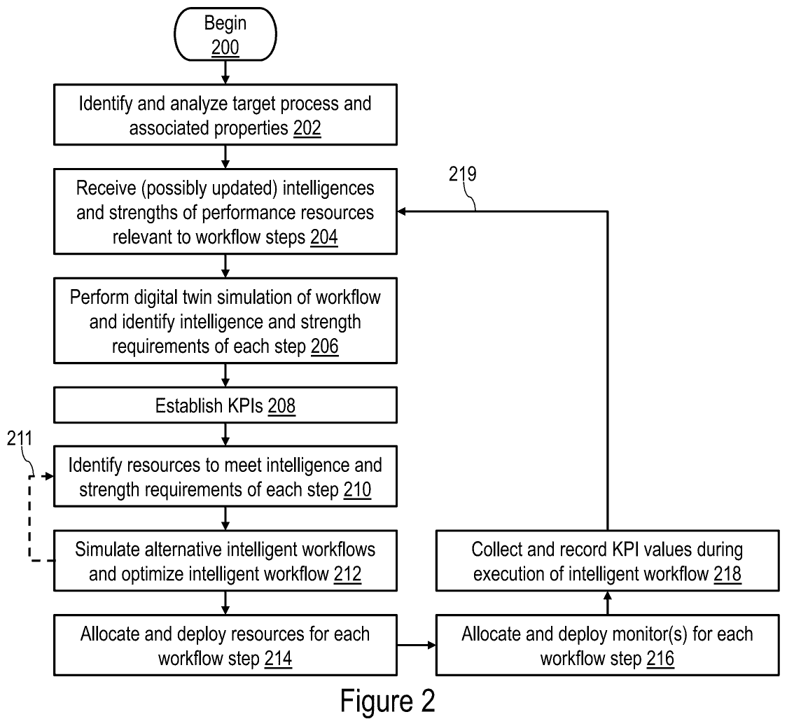

Referring now to FIG. 2, there is depicted a high-level block diagram of an exemplary process of intelligent workflow design in accordance with one or more embodiments. In accordance with one or more embodiments, the process of FIG. 2 can be implemented through the execution of intelligent workflow manager 150 of FIG. 1.

The process of FIG. 2 begins at block 200 and then proceeds to block 202, which illustrates intelligent workflow manager 150 identifying and analyzing a target process for which an intelligent workflow is to be designed and the properties of the process. Block 202 can include, for example, intelligent workflow manager 150 collecting and/or receiving detailed process information, including, for example, process objectives, constituent steps, process inputs, process outputs, step dependencies, safety risks, relevant quality standards for quality control management, and applicable regulations and/or policies for compliance monitoring. In some embodiments, at block 202, intelligent workflow manager 150 decomposes the target process and/or further decomposes one or more of its initially specified set of steps into more granular intelligent workflow steps. In some embodiments, the decomposition of the target process into intelligent workflow steps is guided such that each resulting workflow step is allocable to a single class of performance resource (e.g., computing hardware platform, software and/or firmware code component, human talent, or robotic agent). In some embodiments, intelligent workflow manager 150 can determine the workflow steps based on a dataset of pre-existing intelligent workflows 164, which can be further qualified based on the domain/industry to which the intelligent workflow is applied. In some of these embodiments, intelligent workflow manager 150 can determine the workflow steps utilizing machine learning (ML) and/or artificial intelligence (AI).

At block 202, intelligent workflow manager 150 also receives and/or discovers associated properties of the target process. In at least some embodiments, these properties include operational and/or environmental parameters of the process, activity in physical proximity to the physical production environment in which the target process is performed, and expected duration of execution of the target process. These properties may further include, for each step, workflow step attributes, such as complexity, any required decision-making, challenges, and safety and/or security risks. In at least some embodiments, the properties may include, for example, physical properties for one or more workflow steps, such as physical payload weight (or mass), physical payload volume, physical strength requirements for performance resources, any physical impacts or other dynamic or static stresses, and types of physical payloads. In some embodiments, intelligent workflow manager 150 may receive at least some of the properties of the target process in workflow requirements dataset 158.

Block 204 illustrates that intelligent workflow manager 150 receives various intelligences and strengths of performance resources relevant to the workflow steps of the intelligent workflow. In at least some embodiments, the intelligences and strengths of the performance resources are provided in resource knowledge corpus 156, which can be subject to dynamic update as performance resources change.

Examples of specific types of intelligences can include: (1) safety intelligence—understanding and ensuring compliance with safety and/or security protocols, (2) emotional intelligence—skill at handling human relationships and/or human emotions, (3) cognitive intelligence—skill at solving complex or computationally intensive problems, (4) decision intelligence—ability to apply data science, social science, decision theory, and/or managerial science within a framework to perform organizational decision-making, (5) creative intelligence—skill at generating innovative solutions and/or solving problems, (6) technical intelligence—skill at understanding and applying technical subject matter, and (7) customer intelligence—intelligence regarding deliverables based on contract with customer, which may include incentives and/or penalties for performance or non-performance. In resource knowledge corpus 156, the various types of intelligences may be mapped to various data types and to workflow monitoring devices or sensors to collect data of the various data types. Further, resource knowledge corpus 156 may define a value range or scale of the various types of intelligences to enable intelligent workflow manager 150 to objectively compare and select between the intelligence capability of different performance resources (e.g., a ML platform, a NLP platform, a human worker, a robot, etc.).

The strengths of performance resources identify physical real-world capabilities, such as physical payload lifting capacity, physical payload carrying capacity, physical payload volume, impact resistant qualities, and types of physical payloads handled. In at least some embodiments, the strengths of performance resources can be specified for individual performance resources and/or for classes of performance resources. As a specific example, resource knowledge corpus 156 may specify that all human workers have a maximum payload lifting capacity of 50 lbs.

At block 206, the intelligent workflow and all constituent workflow steps are simulated by digital twin simulation. In some embodiments, intelligent workflow manager 150 directly performs the digital twin simulation of the intelligent workflow. In other embodiments, intelligent workflow manager 150 performs the digital twin simulation indirectly through a separate workflow simulator 152, as will hereafter be assumed. To facilitate the digital twin simulation, intelligent workflow manager 150 and/or workflow simulator 152 first creates a digital twin 160 that serves as a model of the physical production environment in which intelligent workflow is performed and models the performance of all workflow steps and all performance resources involved in performing the workflow steps composing the intelligent workflow. In modeling the physical production environment, workflow simulator 152 replicates all of the production environment's constituent processes, dependencies, and attributes.

After digital twin 160 is created, workflow simulator 152 simulates execution of the intelligent workflow through multiple simulation runs. Each simulation run attempts to accurately mimic the workflow execution, considering the identified complexities, challenges, and risks. Workflow simulator 152 identifies specific intelligence and strength requirements of each workflow step. These intelligence and strength requirements can, for example, specify a respective minimum set of intelligence(s) and minimum quanta of the intelligence(s) and strengths for each workflow step. Workflow simulator 152 preferably employs differing combinations of resources, intelligences, and strengths in the different simulation runs to enable observation of different outcomes of the intelligent workflow under differing operating conditions.

As the simulation runs are executed by workflow simulator 152, workflow simulator 152 and/or intelligent workflow manager 150 gather simulation data of the intelligent workflow and each workflow step, including, for example, performance timing, performance inputs, performance outputs, output quality, performance bottlenecks, and any performance failures. The simulation data gathered at block 206 preferably includes data that is also observable and quantifiable through real-world workflow monitoring.

As depicted at block 208, intelligent workflow manager 150 analyzes the simulation data gathered from the digital twin simulation to correlate workflow outcomes with specific performance metrics. Intelligent workflow manager 150 then filters the performance metrics to identify the set of performance metrics whose values are most determinative of one or more successful simulation outcomes according to one or more metrics of success (e.g., fastest, lowest cost, highest quality, fewest production resources, etc.). Intelligent workflow manager 150 then identifies the filtered set of performance metrics as key performance metrics (KPIs). In at least some embodiments, intelligent workflow manager 150 additionally defines minimum KPI values and/or ranges of required KPI values to ensure effective execution and obtain required outcomes of the intelligent workflow.

Block 210 depicts intelligent workflow manager 150 identifying and tentatively allocating production resources to meet the intelligence and strength requirements of each workflow step identified at block 206. Workflow simulator 152 can then simulate multiple alternative intelligent workflows with different production resources, thus testing the allocation of different types of intelligences and/or different strengths to specific workflow steps (block 212). For example, workflow simulator 152 may increase safety intelligence for workflow steps having higher inherent safety risk and/or enhance emotional intelligence for workflow steps involving human interaction. In some use cases, workflow simulator 152 may additionally simulate different locations of production resources, experimenting with production resource co-location, production resource distribution, and/or hybrid solutions. As indicated by arrow 211, in some embodiments, steps 210-212 may be repeated multiple times, for example, until further improvements in the KPIs established at block 208 drop below a refinement threshold. At the conclusion of the processing performed at block 212, intelligent workflow manager 150 obtains a digital twin 160 having an optimized simulated intelligent workflow having a presently preferred allocation of simulated performance resources (and their associated intelligences and strengths) to workflow steps.

At block 214, intelligent workflow manager 150 allocates and deploys real-world performance resources for each workflow step in the intelligent workflow in accordance with the optimized intelligent workflow produced in block 212. In at least some embodiments, intelligent workflow manager 150 may additionally base performance resource allocation decisions based on existing (historical) intelligent workflows 164, for example, as guided by an integrated ML engine. Allocating the performance resources based on the digital twin simulation and/or existing intelligent workflows 164 ensures allocation of the types and levels of intelligence(s) and physical strength required for various workflow steps. Intelligent workflow manager 150 additionally allocates and deploys, for each workflow step, appropriate workflow monitoring agent(s) 154 to perform workflow monitoring, given the intelligence(s) involved in the workflow step and the KPIs established at block 208 (block 216). Workflow monitoring agents 154 can include, for example, sensors (e.g., Internet-of-things (IOT) sensors), databases, networked external systems, and/or manual input devices.

Intelligent workflow manager 150 collects and records KPI values during execution of each workflow step of the intelligent workflow (block 218). As indicated by arrow 219, the process of FIG. 2 preferably iteratively returns to block 204 and following blocks so that intelligent workflow manager 150 can continually improve the efficiency and effectiveness of the intelligent workflow while taking advantage of any updates to or new availability of performance resources. Intelligent workflow manager 150 preferably makes at least some of the improvements to the intelligent workflow based on the KPI values captured at block 218.

As has been described, in one or more embodiments of a technique of designing an intelligent workflow, a processor determines an intelligent workflow including a plurality of workflow steps to be performed. The processor performs digital twin simulation of performance of the intelligent workflow in a physical production environment. The processor determines, based on the digital twin simulation, at least one type of intelligence among a plurality of types of intelligences to be allocated to each of multiple of the plurality of workflow steps. The processor determines multiple types of intelligences for the plurality of workflow steps. The processor allocates and deploys, in the physical production environment, production resources possessing the determined types of intelligences. The processor thereafter iteratively optimizes the intelligent workflow based on observation of execution of the intelligent workflow by the deployed performance resources in the physical production environment.

While the present invention has been particularly shown as described with reference to one or more preferred embodiments, it will be understood by those skilled in the art that various changes in form and detail may be made therein without departing from the spirit and scope of the invention.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A method of data processing in a data processing system, comprising:
a processor determining an intelligent workflow including a plurality of workflow steps to be performed;
the processor performing digital twin simulation of performance of the intelligent workflow in a physical production environment;
the processor determining, based on the digital twin simulation, at least one type of intelligence among a plurality of types of intelligences to be allocated to each of multiple of the plurality of workflow steps, wherein the determining includes determining multiple types of intelligences for the plurality of workflow steps;
the processor allocating and deploying, in the physical production environment, production resources possessing the determined types of intelligences; and
the processor iteratively optimizing the intelligent workflow based on observation of execution of the intelligent workflow by the deployed performance resources in the physical production environment.

2. The method of claim 1, wherein the plurality of types of intelligences include the following: emotional intelligence, cognitive intelligence, decision intelligence, and creative intelligence.

3. The method of claim 1, further comprising determining, based on the digital twin simulation, a physical strength to be allocated to at least one of the plurality of workflow steps.

4. The method of claim 1, further comprising:
based on the digital twin simulation, determining key performance indicators for the intelligent workflow.

5. The method of claim 4, further comprising:
deploying workflow monitoring agents to monitor at least some of the key performance indicators; and
iteratively improving the intelligent workflow based on values of the key performance indicators.

6. The method of claim 1, wherein the performance resources include at least one code resource, at least one human worker, and at least one robotic resource.

7. A data processing system, comprising:
a processor set; and
a storage device coupled to the processor set, wherein the storage device includes program code executable by the processor set to cause the data processing system to perform:
determining an intelligent workflow including a plurality of workflow steps to be performed;
performing digital twin simulation of performance of the intelligent workflow in a physical production environment;
determining, based on the digital twin simulation, at least one type of intelligence among a plurality of types of intelligences to be allocated to each of multiple of the plurality of workflow steps, wherein the determining includes determining multiple types of intelligences for the plurality of workflow steps;
allocating and deploying, in the physical production environment, production resources possessing the determined types of intelligences; and
iteratively optimizing the intelligent workflow based on observation of execution of the intelligent workflow by the deployed performance resources in the physical production environment.

8. The data processing system of claim 7, wherein the plurality of types of intelligences include the following: emotional intelligence, cognitive intelligence, decision intelligence, and creative intelligence.

9. The data processing system of claim 7, wherein the program code further causes the data processing system to perform:
determining, based on the digital twin simulation, a physical strength to be allocated to at least one of the plurality of workflow steps.

10. The data processing system of claim 7, wherein the program code further causes the data processing system to perform:
based on the digital twin simulation, determining key performance indicators for the intelligent workflow.

11. The data processing system of claim 10, wherein the program code further causes the data processing system to perform:
deploying workflow monitoring agents to monitor at least some of the key performance indicators; and
iteratively improving the intelligent workflow based on values of the key performance indicators.

12. The data processing system of claim 7, wherein the performance resources include at least one code resource, at least one human worker, and at least one robotic resource.

13. A computer program product, comprising:
a storage device; and
program code stored within the storage device and executable by a processor set of a data processing system to cause the data processing system to perform:
determining an intelligent workflow including a plurality of workflow steps to be performed;
performing digital twin simulation of performance of the intelligent workflow in a physical production environment;
determining, based on the digital twin simulation, at least one type of intelligence among a plurality of types of intelligences to be allocated to each of multiple of the plurality of workflow steps, wherein the determining includes determining multiple types of intelligences for the plurality of workflow steps;
allocating and deploying, in the physical production environment, production resources possessing the determined types of intelligences; and
iteratively optimizing the intelligent workflow based on observation of execution of the intelligent workflow by the deployed performance resources in the physical production environment.

14. The computer program product of claim 13, wherein the plurality of types of intelligences include the following: emotional intelligence, cognitive intelligence, decision intelligence, and creative intelligence.

15. The computer program product of claim 13, wherein the program code further causes the data processing system to perform:
determining, based on the digital twin simulation, a physical strength to be allocated to at least one of the plurality of workflow steps.

16. The computer program product of claim 13, wherein the program code further causes the data processing system to perform:
based on the digital twin simulation, determining key performance indicators for the intelligent workflow.

17. The computer program product of claim 16, wherein the program code further causes the data processing system to perform:
deploying workflow monitoring agents to monitor at least some of the key performance indicators; and
iteratively improving the intelligent workflow based on values of the key performance indicators.

18. The computer program product of claim 13, wherein the performance resources include at least one code resource, at least one human worker, and at least one robotic resource.
